(19) United States
(12) Patent Application Publication
(10) Pub. No.: US 2022/0155476 A1
(43) Pub. Date: May 19, 2022

(54) Elastomer sensor clamping

(71) Applicant: Magiq Technologies, Inc., Somerville, MA (US)

(72) Inventors: Nicholas J. Brooks, Somerville, MA (US); Jakob B.U. Haldorsen, Somerville, MA (US)

(21) Appl. No.: 17/531,317

(22) Filed: Nov. 19, 2021

Related U.S. Application Data
(60) Provisional application No. 63/115,733, filed on Nov. 19, 2020.

(51) Int. Cl. G01V 1/52; E21B 47/01

(52) U.S. Cl. CPC G01V 1/52; G01V 2001/526; E21B 47/01

(57) ABSTRACT

Borehole sensor apparatus and methods. The borehole sensor apparatus includes at least one sensor and a first elastomer portion in operable contact with the at least one sensor and configured to be connected to a production tube of a borehole. The elastomer portion is further configured to expand upon exposure to a fluid and move, via the expansion, the sensor away from the production tube to operably contact a casing

### CROSS REFERENCE TO RELATED APPLICATIONS

The present application claims the benefit of and priority to co-pending U.S. provisional application No. 63/115,733, filed on Nov. 19, 2020, the content of which is hereby incorporated by reference as if set forth in its entirety herein.

### TECHNICAL FIELD

Embodiments described herein generally relate to sensors and, more particularly but not exclusively, to systems and methods for configuring sensors in wells or borehole environments.

### BACKGROUND

Wells or boreholes often require sensors to gather imagery or other types of data regarding their environment. These wells typically include a central tube that acts as a conduit for a fluid, such as oil or water. These tubes, commonly known as production tubes, are enclosed within one or more casings.

These structures may be susceptible to damage from environmental factors or from their normal course of operation. At the very least, it is desirable to deploy sensors with or otherwise in proximity to these structures to gather data regarding their operation and their environment. However, deploying these sensors in structures deep within the Earth's surface can be difficult and costly.

A need exists, therefore, for improved methods and systems for configuring sensors in these environments.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a borehole sensor apparatus. The apparatus includes at least one sensor; and a first elastomer portion in operable contact with the at least one sensor and configured to be connected to a production tube of a borehole, wherein the first elastomer portion is further configured to expand upon exposure to a fluid and move, via the expansion, the sensor away from the production tube to operably contact a casing.

In some embodiments, the fluid is a water-based fluid.

In some embodiments, the fluid is an oil-based fluid.

In some embodiments, the at least one sensor includes a seismic tool. In some embodiments, the seismic tool is permanently coupled to the casing after expansion of the elastomer portion or semi-permanently coupled to the casing after expansion of the elastomer portion.

In some embodiments, the at least one sensor includes an acoustic sensor cable. In some embodiments, the apparatus further includes at least a second elastomer portion, wherein the acoustic sensor cable is coupled to the casing by the first elastomer portion and the second elastomer portion after the expansion.

In some embodiments, the apparatus further includes a mandrel housing the elastomer portion.

In some embodiments, the apparatus further includes at least one dissolvable alloy strap securing the elastomer portion to the production tube, wherein the at least one dissolvable alloy strap is configured to dissolve upon the exposure to the fluid.

According to another aspect, embodiments relate to a method of operating a borehole sensor apparatus. The method includes mounting an elastomer portion to a production tube, connecting at least one sensor to the elastomer portion, inserting the production tube into a casing, and allowing the elastomer portion to be exposed to a fluid, wherein the exposure to the fluid causes the elastomer portion to expand to couple the at least one sensor to the casing.

In some embodiments, the fluid is a water-based fluid.

In some embodiments, the fluid is an oil-based fluid.

In some embodiments, the at least one sensor includes a seismic tool. In some embodiments, the seismic tool is permanently coupled to the casing after expansion of the elastomer portion or semi-permanently coupled to the casing after expansion of the elastomer portion.

In some embodiments, the at least one sensor includes an acoustic sensor cable. In some embodiments, the method further includes mounting at least a second elastomer portion to the production tube, wherein the acoustic sensor cable is mounted to the casing by the first elastomer portion and the second elastomer portion after the expansion.

In some embodiments, the method further includes connecting a mandrel housing to the production tube and connecting the elastomer portion to the mandrel housing.

In some embodiments, the method further includes securing the elastomer portion to the production tube via at least one dissolvable alloy strap, and allowing the dissolvable alloy strap to dissolve upon the exposure to the fluid.

According to yet another aspect, embodiments relate to a borehole apparatus. The borehole apparatus comprises at least one sensor; and at least one spring operably connected with the at least one sensor, wherein the spring is configured to be operably secured to a production tube by a dissolvable strap that is configured to dissolve upon exposure to fluid, and move the at least one sensor away from the production tube to operably contact a casing upon the dissolvable strap dissolving.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIGS. 1A & 1B illustrate a top view of a borehole sensor apparatus in accordance with one embodiment;

FIGS. 2A-C illustrate a borehole sensor apparatus in accordance with another embodiment; and

FIGS. 3A-C illustrate a borehole sensor apparatus in accordance with another embodiment;

FIGS. 4A & 4B illustrate a borehole sensor apparatus in accordance with another embodiment; and

FIG. 5 depicts a flowchart of a method of operating a borehole sensor apparatus in accordance with one embodiment

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Boreholes or wells such as those used in drilling operations can extend several hundred feet into the Earth's surface. Structures associated with these operations experience harsh environmental conditions, and it is desirable to deploy sensors to monitor these environments and operational parameters. Due to the depths of these environments, however, it is difficult to deploy, monitor, and repair sensors in these environments.

Continuous seismic analysis can help detect saturations and other phenomena in these environments. This type of analysis can also help generate dynamic reservoir images across a structure and between wells to detect and assess subsurface changes.

However, the data acquisition and processing steps required for continuous seismic analysis are both costly and time consuming. The number of times seismic data is acquired during the lifetime of a field is therefore limited.

With an array of acoustic sensors installed in a borehole, however, active vertical seismic profiling data and passive micro-seismic data can be acquired on demand. Additionally, continuous imagery of a reservoir around the well or borehole can be generated in a timely and cost-effective manner. This imagery can provide data regarding geological structure and sedimentation history, fluid migration pathways, thief zones, potential zones of early breakthrough, injection conformance, and other safety issues.

Existing techniques for deploying these sensors in these environments suffer from numerous shortcomings. For example, existing sensor systems for monitoring these types of environments are complex and costly to implement.

The embodiments herein may include two types of sensors for gathering data regarding a borehole's environment. Specifically, these sensors may provide high resolution, subsurface imagery of structures, wells, and related areas.

One type of sensor may include distributed acoustic sensors. Distributed acoustic sensors provide a near-continuous measurement of an acoustic field along the axis of an optical fiber. The second type of sensor may include three-component (3C) sensors to obtain measurements from discrete, directional optical sensors that are distributed along an optical cable. These types of optical sensors eliminate the need for downhole power sources and other electronics typically associated with conventional systems.

The 3C measurements also resolve any azimuthal ambiguity associated with distributed acoustic measurements and improve the capabilities of vertical seismic profiling. This complete coverage provides continuous, real-time monitoring of the mechanical integrity of the well to detect vibrations and early signs of abnormal activity.

This method of surveillance can continuously monitor weak acoustic activities induced by production or drilling processes and inform operators to take preventive action if certain situations arise. Additionally, Earth movements—related or unrelated to production/injection—can generate small earthquakes that can only be monitored with sensors that are close to the micro-earthquake activity.

A sensor apparatus that includes 3C sensor(s) and distributed acoustic sensors allows for the generation of borehole imagery at lower costs than compared to surface-based methods. Due to the nature of fiber optical sensing, the disclosed systems have a long lifetime in high-temperature wells and can also be installed in subsea wells.

Embodiments described herein provide novel apparatus and methods for implementing sensors in boreholes or other types of environments. To position and secure the sensor(s) in the borehole, the apparatus in accordance with the disclosed embodiments may include an expandable elastomer portion operably connected to an exterior surface of production tubing. The elastomer portion is configured with or otherwise supports at least one sensor device, such as a seismic tool or a DAS cable.

While the production tube is in a casing, the elastomer portion may be exposed to a fluid such as an oil- or water-based fluid and subsequently expand due to said fluid exposure. This expansion moves the sensor(s) away from the production tube and into contact with the casing. This movement isolates the sensor(s) from vibrations of the production tube that would otherwise introduce interference. Additionally, by being coupled to or in contact with the casing, the sensor can gather more accurate and consistent data associated with the casing.

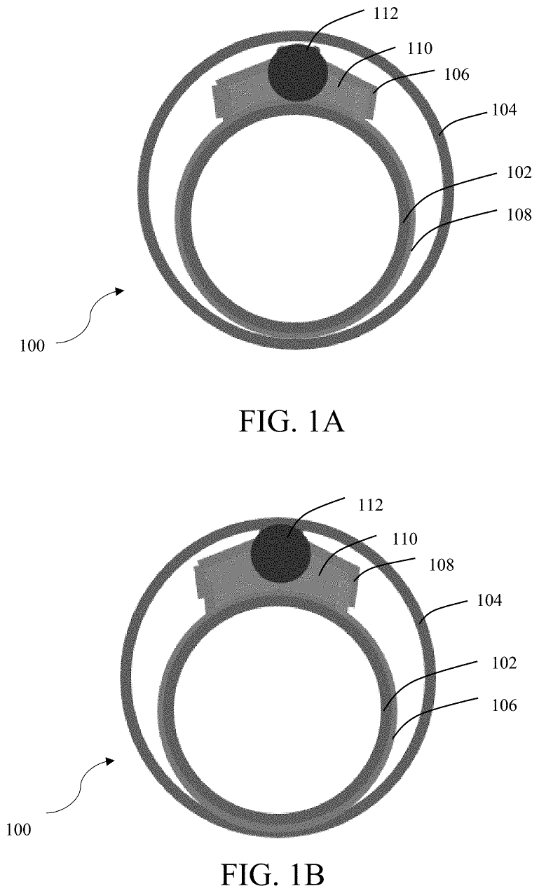

FIGS. 1A & B illustrate a top view of a sensor apparatus 100 in accordance with one embodiment. The apparatus 100 is illustrated in conjunction with a production tube 102 operably positioned within a casing 104. The production tube 102 may be a conduit for oil or water in a drilling operation, for example.

A mandrel 106 may be mounted to the production tube 102 (e.g., by a clamp 108) and filled with one or more elastomer portions 110. The elastomer portion 110 may comprise crosslinked polymer networks that can absorb solvents and swell to many times their initial volume. Accordingly, once the production tube 102 is at an appropriate depth, the elastomer portion 110 may be exposed to a fluid and expand.

The material of the elastomer portion 110 may be chosen to respond to certain fluids. For example, a styrene butadiene rubber swells in oil-based fluids, whereas a hydrogel material swells in water-based fluids. Accordingly, the type of elastomer portion 110 chosen may vary and may depend on the application. Similarly, the rate of swelling or expansion may be dependent on the type of elastomer used.

FIG. 1B illustrates the sensor apparatus 100 with the elastomer portion 110 in an expanded state. As the elastomer portion 110 expands, it forces the sensor 112 away from the production tube 102 and into contact with the casing 104. This ensures the sensor 112 does not detect vibrations from the production tube 102 but is instead coupled with the casing 104.

In the context of the present application, the term “couple” and variants thereof as they pertain to a sensor and a casing means that the sensor is positioned with respect to the casing to obtain desired data associated at least with the casing. In some embodiments, this may refer to the sensor being in direct contact with the casing and being held in place by an adhesive. As another example, the elastomer portion may hold the sensor in place by the elastomer portion's increased volume. Also, and although not shown in FIGS. 1A & B, the sensor apparatus 100 may further include a DAS cable that extends along the length of the production tube 102.

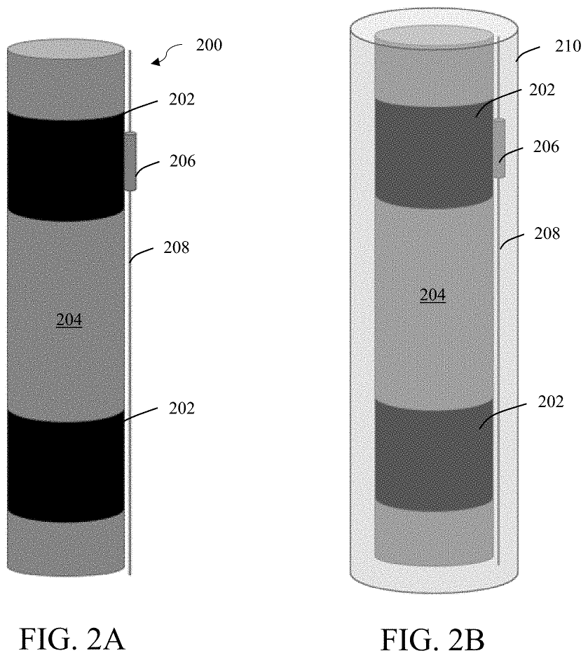

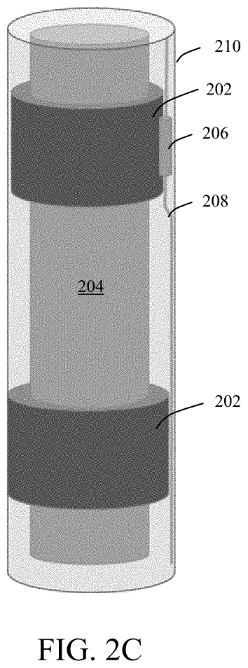

FIGS. 2A-C illustrate a sensor apparatus 200 in accordance with another embodiment. As seen in FIG. 2A, there may be multiple elastomer portions 202 mounted to a production tube 204. Each of the elastomer portions 202 may be configured similarly to each other and may be spaced apart along the production tube 204. Although two elastomer portions 202 are shown in FIGS. 2A-C, any number of elastomer portions 202 may be used and may depend on factors such as the length of the production tube 204 and the application.

One or more of the elastomer portions 202 may include or otherwise be configured with a sensor 206 as in FIGS. 1A & 1B. Also shown in FIGS. 2A-C is a DAS cable 208. The DAS cable 208 may be operably connected to (e.g., pass through) the elastomer portion 202 and run along at least a portion of the length of the production tube 204.

FIG. 2B illustrates the production tube 204 and associated components within a casing 210. The casing 210 may be of a sufficient diameter to contain the production tube 204 and form an annulus between the outer surface of the production tube 204 and the inner surface of the casing 210.

As or after the production tube is 204 is moved to depth within the casing 210, fluid may contact the elastomer portions 202 and cause them to swell, expand, or otherwise increase in volume. The type of elastomer portion used may vary and may depend on the application or environment. As discussed above, in some embodiments the elastomer portions 202 may expand upon being exposed to water. In other embodiments, the elastomer portions 202 may expand upon being exposed to oil.

For example, FIG. 2C illustrates the elastomer portions 202 in an expanded state. As seen in FIG. 2C, as the elastomer portions 202 expand, they push the sensor 206 away from the production tube 204 and into contact with the casing 210. The DAS cable 208 will be pushed towards the casing 210 or other type of formation for improved coupling and signal along the length of the borehole.

The vector fidelity of the sensor 206 may define its ability to correctly record the direction of particle motion of the formation with which the sensor 206 is coupled. The vector fidelity combines the ability of the sensor 206 to accurately record particle motion, with the quality of the coupling of the sensor 206 with the formation. It is therefore important that, in these embodiments, the DAS cable 208 and the sensor(s) 206 are both coupled to the outer layer of the well, such as the casing 210 or other type of formation.

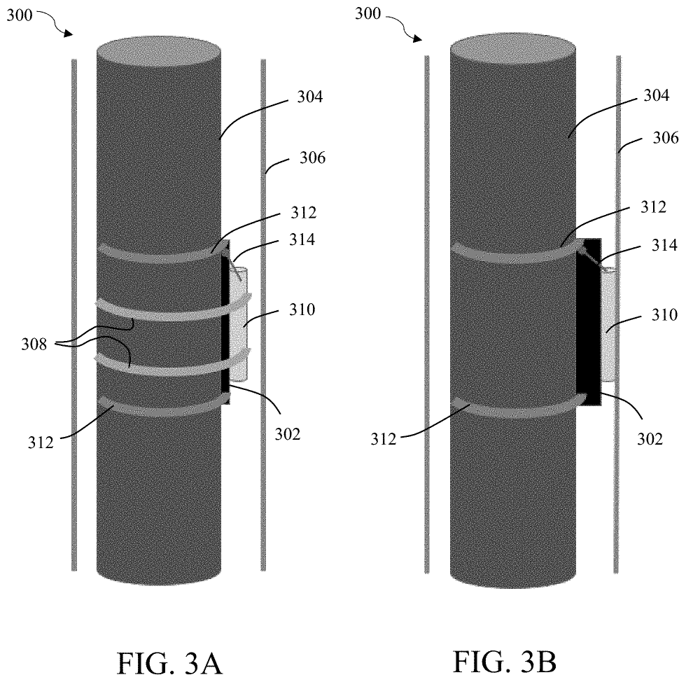

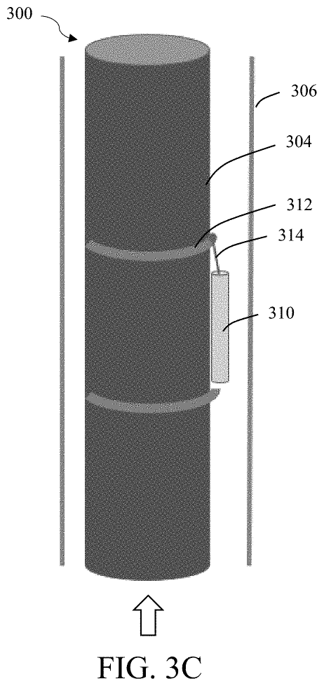

FIGS. 3A-C illustrate a sensor apparatus 300 in accordance with another embodiment. FIGS. 3A-C illustrate an elastomer portion 302 secured to a production tube 304 that is positioned within a casing 306. These embodiments include one or more dissolvable alloy straps 308 that mount the elastomer portion 302 and sensor 310 to the production tube 304. These embodiments may also include one or more brackets 312 to further secure the elastomer portion 302 to the production tube 304.

In some embodiments, the sensor 310 or other sensors described herein may be similar to applicant's GeoLite™ sensor. Regardless of the exact type or configuration of the sensor 310 used, the apparatus 300 may include one or more retrieving arms 314 to help secure the sensor 310 in place.

As in previous embodiments, the production tube 304 and associated components may be inserted into the casing 306 of a well or borehole. Once at depth, fluid may contact components such as the elastomer portion 302 and the dissolvable alloy straps 308.

As seen in FIGS. 3B, contact with this fluid causes the alloy straps 308 to dissolve and the elastomer portion 302 to expand. As the straps 308 dissolve, the expansion of the elastomer portion 302 pushes the sensor 310 into contact with the casing 306. The retrieving arm 314 may help secure the sensor 310 with respect to the casing 306. Additionally or alternatively, the sensor 310 may be operably secured to the casing 306 using any appropriate mounts, adhesives, or the like.

FIG. 3C illustrates the apparatus 300 during a workover stage in accordance with one embodiment. For example, the elastomer portion 302 may crumble, bringing the sensor 310 away from the casing 306. The sensor 310 may then be brought to the surface for maintenance, repair, or replacement.

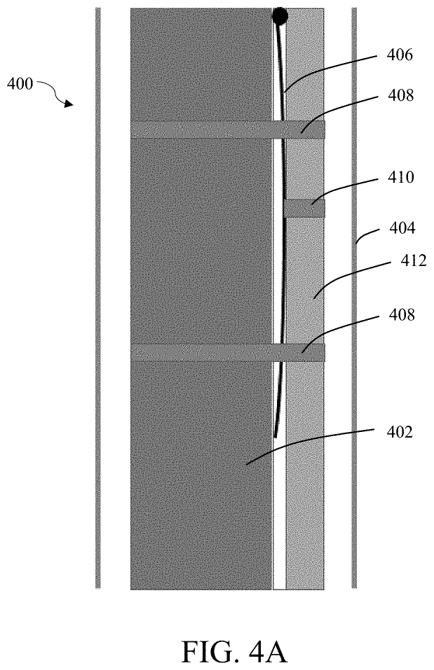

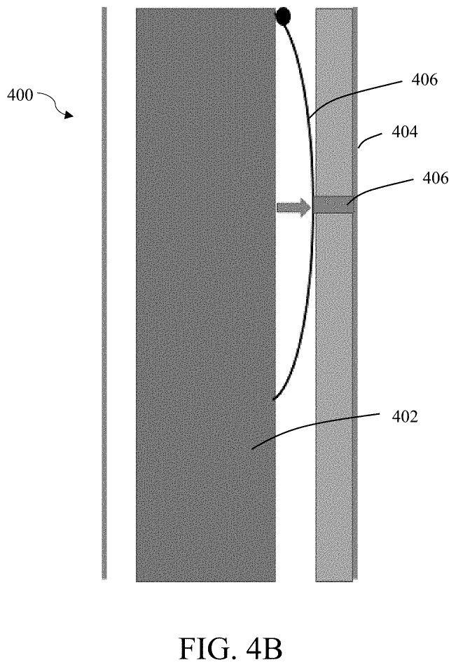

FIGS. 4A & B illustrate a sensor apparatus 400 in accordance with another embodiment. As in previous embodiments, the sensor apparatus 400 is illustrated in conjunction with a production tube 402 positioned within a casing 404.

The sensor apparatus 400 also includes a spring 406 that is temporarily secured to the production tube 402 by one or more dissolvable alloy straps 408. The spring 406 is biased outward (i.e., away from the production tube 402) but held in place by the straps 408. Also shown in FIGS. 4A & B is an anchor strap 410 that secures a sensor 412 to the spring 406.

FIG. 4B illustrates the components of the sensor apparatus 400 after exposure to a fluid. As seen in FIG. 4B, the alloy straps 408 of FIG. 4A have dissolved. This releases the spring 406 and, due to its bias, pushes the sensor 412 away from the production tube 402 and into contact with the casing 404. The sensor 412 is then coupled with the casing 404 for monitoring and gathering data as discussed previously.

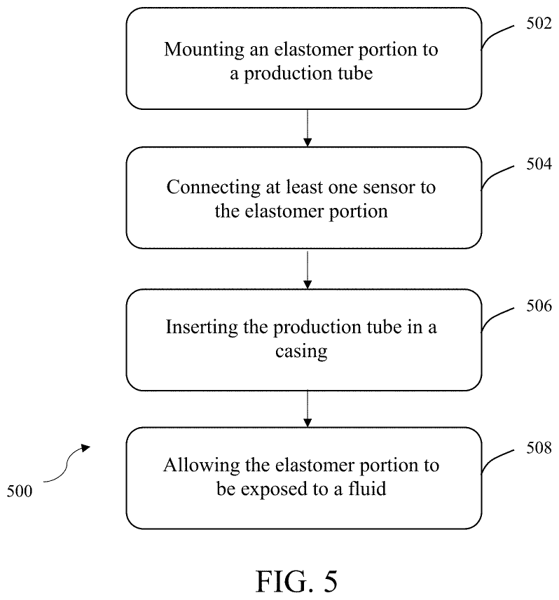

FIG. 5 depicts a flowchart of a method 500 of operating a borehole sensor apparatus in accordance with one embodiment. Step 502 involves mounting an elastomer portion to a production tube. The production tube may be a conduit for a fluid such as oil. In this application, the production tube may ultimately be inserted into a casing as part of a drilling or extraction operation. The material of the elastomer portion may comprise crosslinked polymer networks and may be chosen to respond to certain fluids as discussed previously.

The elastomer portion may be mounted to the production tube in a variety of ways. For example, the elastomer portion may be configured in or otherwise with a mandrel portion that attaches to a portion of the production tube as in FIGS. 1A-C. In other embodiments, the elastomer portion may attach directly to the surface of the production tube as in FIGS. 2A-C. In other embodiments, the elastomer portion may initially be secured to the production tube by dissolvable straps as in FIGS. 3A-C.

Step 504 involves connecting at least one sensor to the elastomer portion. The sensor(s) may be configured as a multi-component 3C Fiber Optic system to obtain seismic and micro-seismic data associated with the borehole environment. The sensor may be attached to the elastomer portion in a variety of ways, such as via an adhesive or a strap such as the strap 410 of FIGS. 4A & B.

Step 506 involves inserting the production tube into a casing. As discussed previously, the production tube and casing may be implemented in applications such as drilling operations. Once the elastomer portion, sensor(s), and any other appropriate components are configured with the production tube, the tube may be lowered into a casing.

Step 508 involves allowing the elastomer portion to be exposed to a fluid, wherein the exposure to the fluid causes the elastomer portion to expand to couple the at least one sensor to the casing. Once the production tube is the appropriate depth, the elastomer portion may be exposed to a fluid such as an oil-based or water-based fluid.

The expansion of the elastomer portion pushes the sensor away from the production tube and into contact with the casing, thereby coupling the sensor to the casing. The technique(s) ultimately used to couple the sensor with the casing may vary as long as the sensor can obtain the desired data associated with the casing or the borehole's environment.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, apparatuses, and systems according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A borehole sensor apparatus comprising:
at least one sensor; and
a first elastomer portion in operable contact with the at least one sensor and configured to be connected to a production tube of a borehole, wherein the first elastomer portion is further configured to:
expand upon exposure to a fluid, and
move, via the expansion, the sensor away from the production tube to operably contact a casing.

2. The sensor apparatus of claim 1 wherein the fluid is a water-based fluid.

3. The sensor apparatus of claim 1 wherein the fluid is an oil-based fluid.

4. The sensor apparatus of claim 1 wherein the at least one sensor includes a seismic tool.

5. The sensor apparatus of claim 4 wherein the seismic tool is permanently coupled to the casing after expansion of the elastomer portion or semi-permanently coupled to the casing after expansion of the elastomer portion.

6. The sensor apparatus of claim 1 wherein the at least one sensor includes an acoustic sensor cable.

7. The sensor apparatus of claim 6 further comprising at least a second elastomer portion, wherein the acoustic sensor cable is coupled to the casing by the first elastomer portion and the second elastomer portion after the expansion.

8. The sensor apparatus of claim 1 further comprising a mandrel housing the elastomer portion.

9. The sensor apparatus of claim 1 further comprising at least one dissolvable alloy strap securing the elastomer portion to the production tube, wherein the at least one dissolvable alloy strap is configured to dissolve upon the exposure to the fluid.

10. A method of operating a borehole sensor apparatus, the method comprising:
mounting an elastomer portion to a production tube;
connecting at least one sensor to the elastomer portion;
inserting the production tube into a casing; and
allowing the elastomer portion to be exposed to a fluid, wherein the exposure to the fluid causes the elastomer portion to expand to couple the at least one sensor to the casing.

11. The method of claim 10 wherein the fluid is a water-based fluid.

12. The method of claim 10 wherein the fluid is an oil-based fluid.

13. The method of claim 10 wherein the at least one sensor includes a seismic tool.

14. The method of claim 13 wherein the seismic tool is permanently coupled to the casing after expansion of the elastomer portion or semi-permanently coupled to the casing after expansion of the elastomer portion.

15. The method of claim 10 wherein the at least one sensor includes an acoustic sensor cable.

16. The method of claim 15 further comprising mounting at least a second elastomer portion to the production tube, wherein the acoustic sensor cable is mounted to the casing by the first elastomer portion and the second elastomer portion after the expansion.

17. The method of claim 10 further comprising:
connecting a mandrel housing to the production tube, and
connecting the elastomer portion to the mandrel housing.

18. The method of claim 10 further comprising securing the elastomer portion to the production tube via at least one dissolvable alloy strap, and allowing the dissolvable alloy strap to dissolve upon the exposure to the fluid.

19. A borehole sensor apparatus comprising:
at least one sensor; and
at least one spring operably connected with the at least one sensor, wherein the spring is configured to:
be operably secured to a production tube by a dissolvable strap that is configured to dissolve upon exposure to fluid, and
move the at least one sensor away from the production tube to operably contact a casing upon the dissolvable strap dissolving.
